(19) United States
(12) Patent Application Publication
(10) Pub. No.: US 2017/0294187 A1
(43) Pub. Date: Oct. 12, 2017

(54) SYSTEMS AND METHOD FOR PERFORMING SPEECH RECOGNITION

(71) Applicant: HONEYWELL INTERNATIONAL INC., Morris Plains, NJ (US)

(72) Inventors: Martin Dostal, Olomouc (CZ); Pavel Kolcarek, Brno (CZ)

(73) Assignee: HONEYWELL INTERNATIONAL INC., Morris Plains, NJ (US)

(21) Appl. No.: 15/092,018

(22) Filed: Apr. 6, 2016

(51) Int. Cl. G10L 15/19; G10L 15/22

(52) U.S. Cl. CPC G10L 15/19; G10L 15/22; G10L 2015/221; G10L 2015/223; G10L 2015/226

(57) ABSTRACT

A system and method for performing speech recognition. A speech recognition engine includes a plurality of grammar paths each defining a recognized phrase. The grammar paths each have at least two nodes that are connected by a recognized word. An input device receives a user specified input that corresponds to the recognized word. A microphone receives a user phrase and a processor excludes grammar paths from the speech recognition engine based on an absence of the user specified input. The processor selects the recognized phrase from the non-excluded grammar paths based on the user phrase.

### TECHNICAL FIELD

The present invention generally relates to speech recognition systems, and more particularly relates to systems and methods for simplifying grammar paths in a speech recognition engine.

### BACKGROUND

Speech recognition systems allow for the conversion of spoken language into text using computer systems. In this way, spoken words from a user may be converted into text that can more easily be interpreted by computers and disseminated amongst various electronic systems. Initially, speech recognition systems were only able to identify a limited number of words and simple phrases, such as instructions to call a phone number or input an address into a navigation system. These basic systems had a relatively small number of words that they could identify so only a limited number of phrases or grammar paths could be made by combining the words. However, as speech recognition has become more sophisticated, systems have been able to identify more words and the advanced and complex grammar used in normal human speech. Accordingly, as the number of words and grammar rules understood by the system increases, the number of grammar paths and combinations of words increases almost exponentially.

In order to cope with the increased number of possible grammar paths, conventional systems use algorithms or models to statistically model and breakdown audible speech into discrete components. These components or nodes are then linked by the system to form the grammar path that matches the spoken phrase. In this way, the system effectively compares the components of the spoken phrase iteratively against all of the recognized words within the database. While grammar rules may be programmed into the system to help improve the accuracy and reduce the computational demand of on the system, the sheer number of combinations and sub combinations of words used to form the grammar paths remains a computationally demanding process.

Accordingly, it is desirable to provide systems and methods for simplifying grammar paths in a speech recognition engine. In addition, it is desirable to provide systems and methods that use user specified inputs to exclude grammar paths from a speech recognition engine. Furthermore, other desirable features and characteristics of the present invention will become apparent from the subsequent detailed description of the invention and the appended claims, taken in conjunction with the accompanying drawings and this background of the invention.

### BRIEF SUMMARY

A system for performing speech recognition includes a speech recognition engine including a plurality of grammar paths that each define a recognized phrase. The grammar paths each have at least two nodes that are connected by a recognized word. The system further includes an input device that is configured to receive a user specified input corresponding to the recognized word. The system further includes a microphone that is configured to receive a user phrase. The system further includes a processor that is configured to exclude grammar paths from the speech recognition engine based on an absence of the user specified input and select the recognized phase from the non-excluded grammar paths based on the user phrase.

A system for simplifying grammar paths in a speech recognition engine includes an input device that is configured to receive a user specified input corresponding to a recognized word of the grammar paths. The system further includes a microphone that is configured to receive a user phrase. The system further includes a processor that is configured to exclude grammar paths from the speech recognition engine based on an absence of the user specified input and select the recognized phrase from the non-excluded grammar paths based on the user phrase.

A method for performing speech recognition includes receiving a user specified input with an input device. The method further includes identifying a recognized word based on the user specified input. The method further includes excluding grammar paths from a speech recognition engine based an absence of the recognized word in the grammar paths. The method further includes receiving a user phrase with a microphone and selecting a recognized phrase from the non-excluded grammar paths based on the user phrase.

### BRIEF DESCRIPTION OF THE DRAWINGS

The present invention will hereinafter be described in conjunction with the following drawing figures, wherein like numerals denote like elements, and

FIG. 1 is a simplified block diagram of an exemplary system for performing speech recognition according to an embodiment;

FIGS. 2A-C are a series of state transition diagrams illustrating a non-limiting example of the operation of the system of FIG. 1 according an embodiment;

FIG. 3 is a simplified flow diagram of a method for performing speech recognition according to an embodiment; and

FIG. 4 is a simplified flow diagram of a method for performing speech recognition according to an embodiment.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

Those of skill in the art will appreciate that the various illustrative logical blocks, modules, circuits, and algorithm steps described in connection with the embodiments disclosed herein may be implemented as electronic hardware, computer software, or combinations of both. Some of the embodiments and implementations are described below in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps are described herein generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations.

The various illustrative logical blocks, modules, and circuits described in connection with the embodiments disclosed herein may be implemented or performed with a general purpose processor, a controller, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

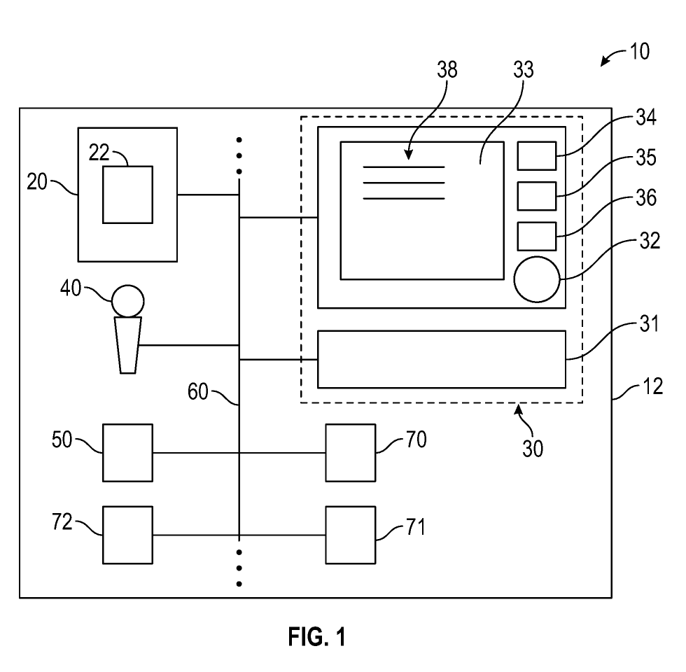

With reference to FIG. 1, there is shown a non-limiting example of a system 10 for performing speech recognition. It should be appreciated that the overall architecture, setup and operation, as well as the individual components of the illustrated system 10 are merely exemplary and that differently configured systems may also be utilized to implement the examples of the system 10 disclosed herein. Thus, the following paragraphs, which provide a brief overview of the illustrated system 10, are not intended to be limiting.

In an embodiment, the system 10 is generally implemented on a vehicle 12. The system 10 includes a speech recognition engine 20, an input device 30, a microphone 40, and a processor 50 in communication over a bus CO. The term “device,” as used herein, generally refers to electronic component and may include a processor in communication with a memory as is known to those skilled in the art, and is not intended to be limiting. The vehicle 12 may be any type of mobile vehicle such as a car, truck, boat, plane, etc., and may be equipped with additional vehicle systems 70-72 in addition to the system 10. The speech recognition engine 20, input device 30, microphone 40, and processor 50 are onboard the vehicle 12 and operatively coupled to the bus CO.

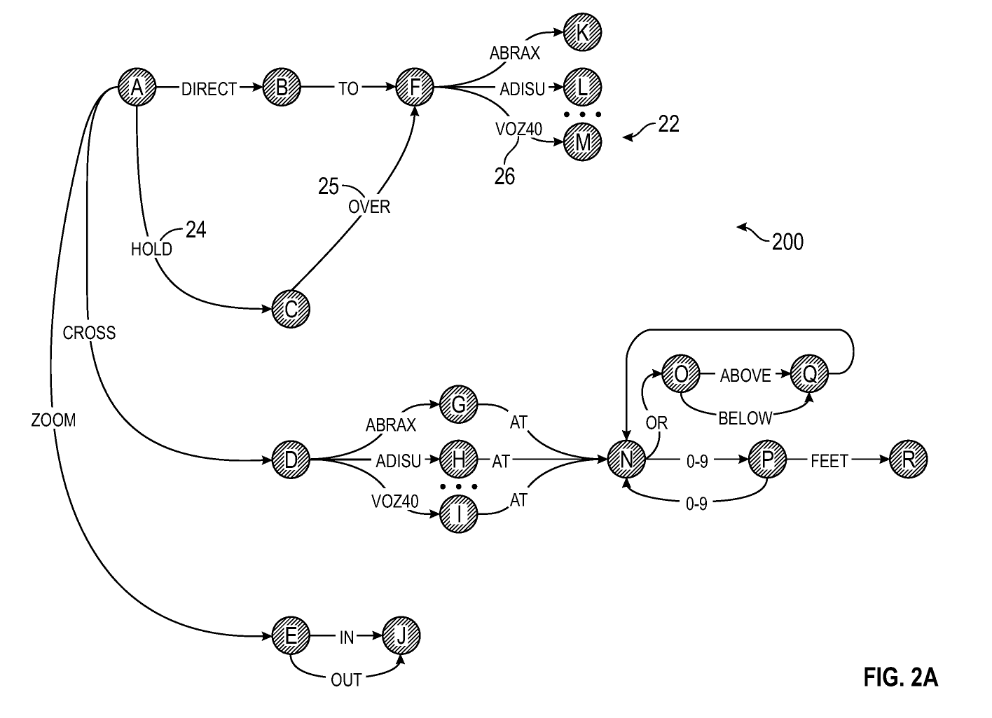

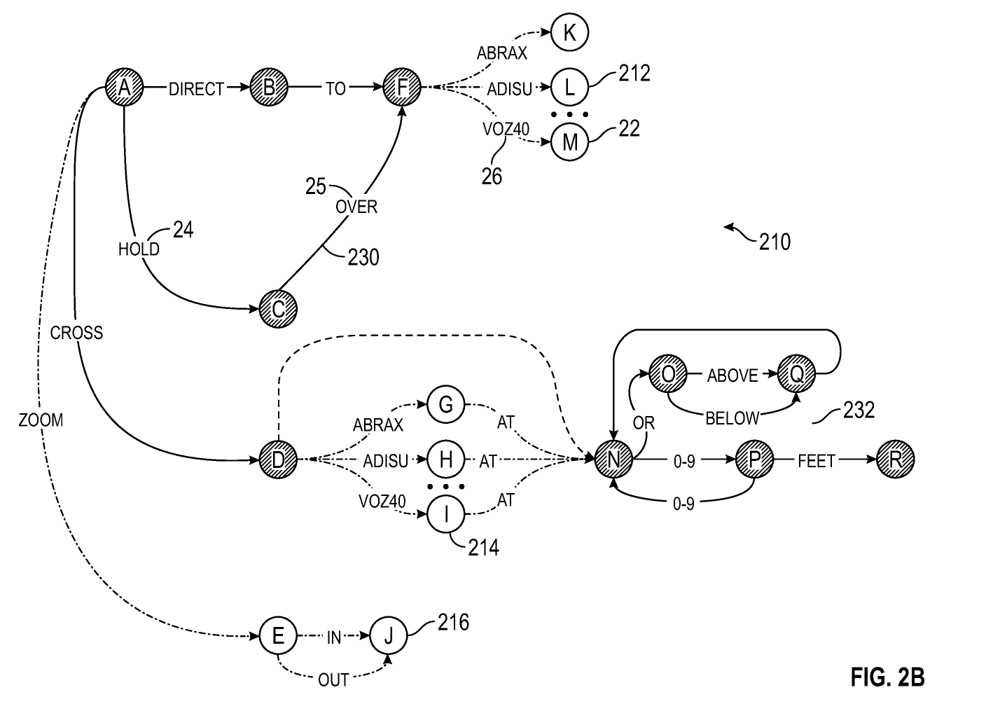

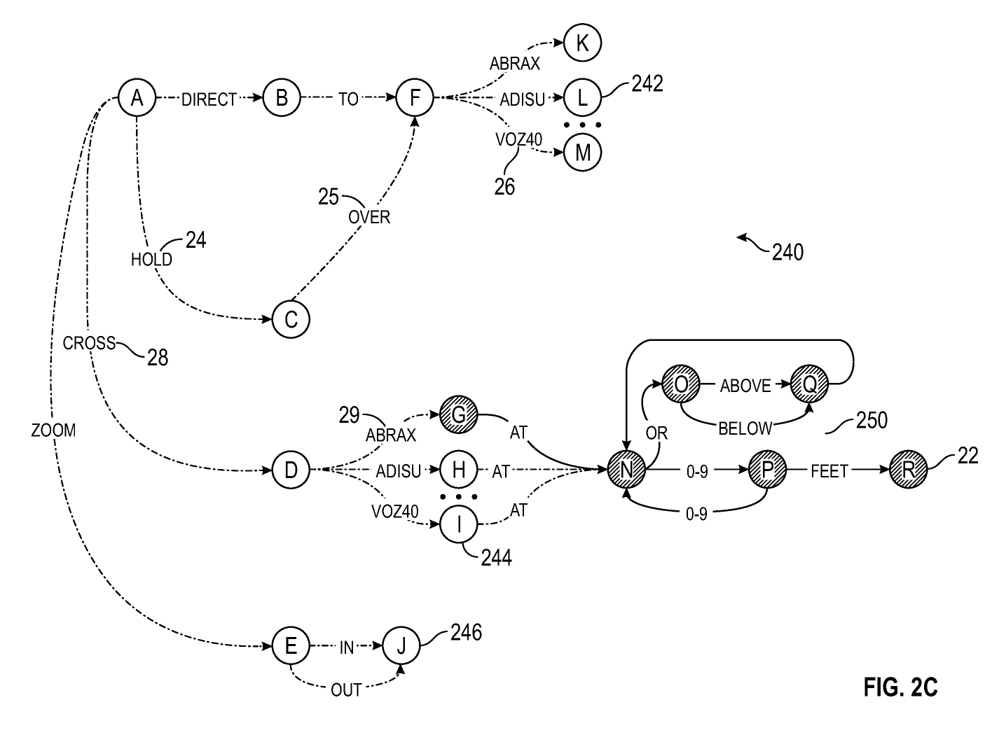

In an embodiment, and with further reference to FIG. 2A the speech recognition engine 20 includes a plurality of grammar paths 22 that each define a recognized phrase of the speech recognition engine 20. In a non-limiting embodiment, the speech recognition engine 20 is implemented in software as a program or module that is configured to communicate with other systems of the vehicle 12 using the bus 60. The recognized phrases correspond to the spoken phrases that the speech recognition engine 20 is able to identify and convert into text. One skilled in the art will appreciate that the specific recognized phrases are design choices that depend on the vehicle 12 in which the system 10 is implemented, phrases that may need to be recognized, etc., and the phrases described herein and depicted in the Figures should not be interpreted as limiting.

The grammar paths 22 each have at least two nodes A-R that are connected by a recognized word 24-26. FIG. 2A depicts an exemplary state transition diagram 200 having, nodes A-R that are connected by recognized words 24-26 to form grammar paths. For example, node A is connected to node B by recognized word 24, node B is connected to node F by recognized word 25, and node F is connected to node M by recognized word 26 to define the grammar path 22 or recognized phrase A-C-F-M.

The nodes A-R are arranged into grammar paths 22 according to phrases or instructions that are expected to be handled by the speech recognition engine 20. For example, in a vehicle 12 such as an automobile, the speech recognition engine 20 may need to interpret instructions to call a contact from a user's phone book, enter an address into a navigation system, or operate an infotainment system, In another example, the vehicle 12 may be an aircraft in which case the speech recognition engine 20 may need to interpret completely different instructions than in an automobile, such as to operate an autopilot system, enter a heading, adjust a radio frequency, or operate a pilot information system. Accordingly, the specific layout of the nodes A-R within the state transition diagram 200 and the recognized words 24-26 that connect the nodes A-R will depend on the intended application for the speech recognition engine 20.

In an embodiment, the system 10 is a multimodal speech recognition system 10. Multimodal speech recognition systems 10 support multimodal utterances to allow for speech recognition of instructions that combine both spoken commands and inputs from other devices. For example, a user phrase of “DIRECT TO ABRAX” may not be provided only by voice but through a combination of voice and another input. A user may speak “DIRECT” while inputting the other part of the phrase by another modality, such as entering “ABRAX” on a keyboard or highlighting a waypoint object labeled “ABRAX” on a lateral map using a cursor control device. One skilled in the art will appreciate that this flexibility in the mode of interaction between the user and the speech recognition system 10 makes accurate speech recognition by the speech recognition engine 20 difficult.

Multimodal speech recognition systems 10 that support multimodal utterances to the speech recognition engine 20 need to accept not only the whole spoken phase such as “DIRECT TO ABRAX” but also a subset of the phrase such as “DIRECT TO”; “DIRECT”' “TO ABRAX”; and “ABRAX.” Accordingly, the number of acceptable utterances and the complexity of the grammar, vocabulary, etc., handled by the system 10 and the speech recognition engine 20 rapidly increases. Furthermore, the utterances and subsets are often short single or two word phrases that are hard for speech recognition engines 20 to recognize compared to longer, better-structured phrases. This issue is further accentuated in recognition of categories of words, such as destinations or airport codes, which have large data sets which result in many combinations based on accepting single word utterances.

While state of the art systems such as deep neural networks provide the raw computing power and high-speed internet connection to allow for multimodal speech recognition systems 10 to accurately interpret speech, these systems are not always practical to implement in real world scenarios. For example, the accuracy of speech recognition may be negatively impacted by background noise, limited computation power and memory resources, and lack of a stable high-speed internet connection.

The input device 30 is configured to receive a user specified input corresponding to the recognized word 24-26. As detailed above with respect to the multimodal speech recognition system 10, the input device 30 allows for a user to input a recognized word 24-26 or a portion of what will ultimately be the recognized phrase into the speech recognition system 10. In a non-limiting embodiment, the input device 30 includes a keyboard 31, a cursor control device 32, a touchscreen 33, a soft key or customizable button 34-36, or a combination thereof.

The input device 30 provides the system 10 with an input that is comparably easy to interpret, relative to an instruction obtained through speech recognition. For example, a typed phrase entered by the user or a destination highlighted and selected by the user is already in a form that can be easily interpreted by the speech recognition system 10.

The microphone 40 is operatively in communication with the bus 60 and is configured to receive a user phrase. The microphone 40 converts sound, specifically the user phrase spoken by the user, into an electrical signal.

The processor 50 is operatively in communication with the bus 60 and is configured to exclude grammar paths 22 from the speech recognition engine 20 based on an absence of the user specified input. The processor 50 is further configured to select the recognized phrase from the non-excluded grammar paths 22 based on the user phrase received by the microphone 40.

As detailed above, multimodal speech recognition systems 10 are tasked with recognizing a large number of words and phrases while also considering various grammatical arrangements and combinations of both spoken user phrases and user specified inputs from input devices 30. The processor 50 of the system 10 uses the user specified input from the input device 30 to exclude grammar paths 22 from the speech recognition engine 20. For example, if a user specified input includes a destination, corresponding to a recognized word 24-26, entered on a keyboard 31 by the user, the processor 50 excludes grammar paths 22 from the speech recognition engine 20 that do not contain the recognized word 24-26. Stated differently, the since the multimodal speech recognition system 10 knows that the recognized phrase, which is the combination of the user phrase and the user specified input, must contain the user specified input, the processor 50 excludes the grammar paths that do not contain the recognized word that corresponds to the user specified input. The system 10 can now more easily perform the speech recognition by selecting the recognized phrase from the non-excluded grammar paths.

The operation of the system 10 will now be described with respect to the state transition diagrams of FIGS. 2A-C, As detailed above, FIG. 2A depicts an exemplary state transition diagram 200 having nodes A-R that are connected by recognized words 24-26 to form grammar paths. None of the grammar paths 22 in the state transition diagram 200 have been excluded and the state transition diagram 200 may be thought of as the initial state of the speech recognition engine 20. Throughout the description of FIGS. 2A-C, the labeling of the nodes A-R and the recognized words 24-26 will remain constant to aid in the understanding of the operation of the system 10.

FIG. 2B depicts a state transition diagram 210 containing excluded grammar paths 212, 214, 216 and non-excluded grammar paths 230, 232. In a non-limiting example, the user selects on the touchscreen 33 a user specified input “VOZ40 ” corresponding to the recognized word 26 and speaks the user phrase “HOLD OVER” into the microphone 40. Accordingly the recognized phrase that the system 10 should select is “HOLD OVER VOZ40” which corresponds to the grammar path 22 formed by connecting nodes A-C-F-M. As the system 10 knows that the recognized phrase will contain “VOZ40,” the system 10 is able to exclude grammar paths that do not contain the recognized word “VOZ40,” and further can exclude nodes connected to “VOZ40” as these will not need to be evaluated.

The processor 50 excludes the excluded grammar paths 212, 214, 216 from the speech recognition engine 20 based on the recognized word 26 which results in the state transition diagram 210. Stated differently, the processor 50 is able to reduce the total number of potential grammar paths that may match the user phrase by excluding the excluded grammar paths 212, 214, 216 from the state transition diagram 210 since they do not contain the recognized word 26 corresponding to the user specified input.

Relative to the state transition diagram 200 of FIG. 2A, the processor 50 has excluded eight nodes that would otherwise need to be evaluated, which reduces the computational demand. In addition, by treating the user specified input as a known variable and excluding the excluded grammar paths 212, 214, 216, the multimodal speech recognition system 10 is able to more accurately combine the user phrase with the recognized word and select to recognized phrase from the speech recognition engine 20.

FIG. 2C depicts a state transition diagram 240 containing excluded grammar paths 242, 244, 246 and non-excluded grammar path 250. In a non-limiting example, the user types on the keyboard 31 a user specified input “CROSS ABRAX” corresponding to the recognized words 28, 29 and speaks the user phrase “AT 8 FEET” into the microphone 40. Accordingly the recognized phrase that the system 10 should select is “CROSS ABRAX AT 8 FEET” which corresponds to the grammar path 22 formed by connecting nodes A-D-G-N-P-R. As the system 10 knows that the recognized phrase will contain “CROSS ABRAX” in that order, the system 10 is able to exclude not only grammar paths that do not contain both the recognized words, but further excludes grammar paths that do not contain the recognized words in that specific order.

The processor 50 excludes the excluded grammar paths 242, 246, 248 from the speech recognition engine 20 based on the recognized words 28, 29 which results in the state transition diagram 240. Stated differently, the processor 50 is able to reduce the total number of potential grammar paths that may match the user phrase by excluding the excluded grammar paths 242, 246, 248 from the state transition diagram 240 since they do not contain the recognized word 28, 29 corresponding to the user specified input in their entered order.

Relative to the state transition diagram 200 of FIG. 2A, the processor 50 has excluded twelve nodes that would. otherwise need to be evaluated, which reduces the computational demand. In addition, by treating the user specified input as a known variable and excluding the excluded grammar paths 242, 246, 248, the multimodal speech recognition system 10 is able to more accurately combine the user phrase with the recognized word and select the recognized phrase from the speech recognition engine 20.

In a non-limiting embodiment, the processor 50 is further configured to provide the recognized phrase to additional vehicle systems 70-72. In a non-limiting embodiment, the vehicle systems 70-72 include at least one of a navigation system 70, a communication system 71, a vehicle control system 72, or a combination thereof.

In a non-limiting embodiment, the system 10 further includes a display 38 that is configured to display the recognized phrase to the user. Accordingly, the user can then confirm that the recognized phrase is in fact the desired phrase the user wished to enter into the system.

In a non-limiting embodiment, the system 10 further includes a first input device 31-36 configured to receive a first user specified input corresponding to a first recognized word. The system 10 further includes a second input device 31-36 configured to receive a second user specified input corresponding to a second recognized word. In a non-limiting embodiment, the processor 50 is configured to exclude grammar paths 22 from the speech recognition engine 20 based on the absence of the first and second specified inputs and determine the recognized phrase based on the user phrase and the non-excluded grammar paths. In a non-limiting example, a user types the first user specified input with the keyboard 31 and selects the second user specified input with the touchscreen 33. The system 10 uses the recognized words that correspond to the first and second user specified inputs to exclude grammar paths from the speech recognition engine 20.

In a non-limiting embodiment, the processor 50 is further configured to identify a position of the user specified input within the non-excluded grammar paths and exclude additional grammar paths based on the position. For example, the user specified input may correspond to a recognized word 24-26 that is present in multiple grammar paths 22. In addition to excluding the grammar paths that do not contain the recognized word 24-26, the processor 50 can identify the position of the recognized word 24-26 by performing partial speech recognition on the user phrase. As speech recognition is performed on the user phrase, the processor 50 can exclude additional grammar paths that do not contain the recognized word in a position that is compatible with the partially recognized phrase.

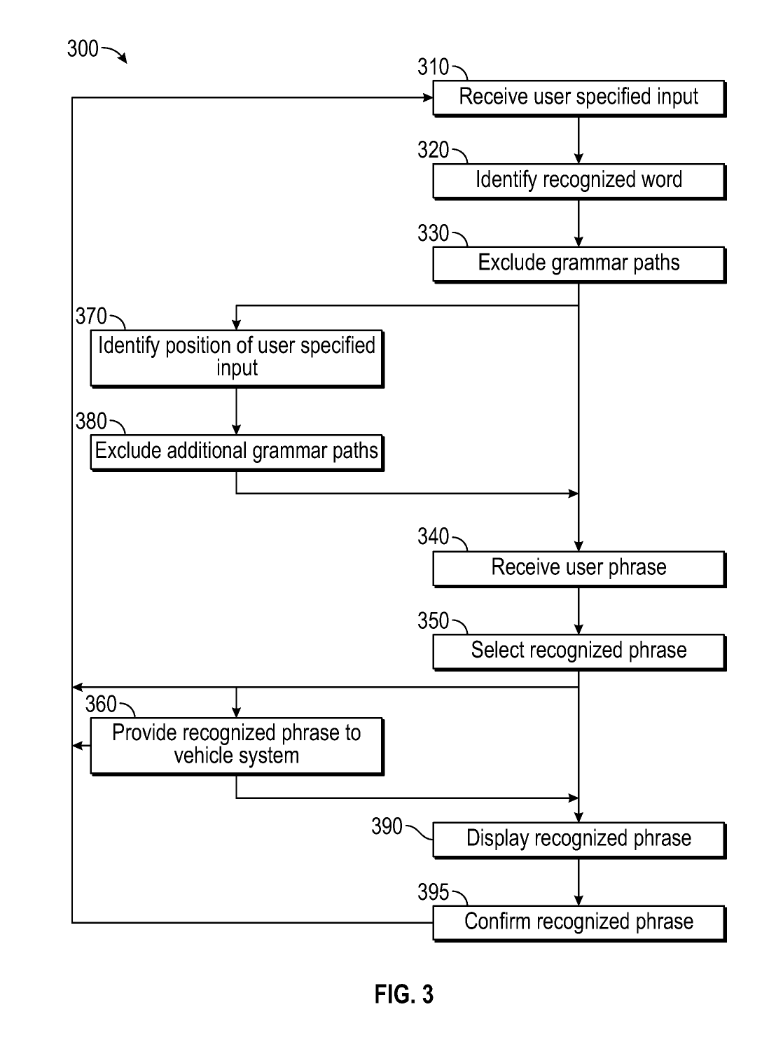

Referring now to FIG. 3, and with continued reference to FIGS. 1-2, a flowchart illustrates a method 300 performed by the system 10 for performing speech recognition in accordance with the present disclosure. As can be appreciated in light of the disclosure, the order of operation within the method 300 is not limited to the sequential execution as illustrated in FIG. 3, but may be performed in one or more varying orders as applicable and in accordance with the requirements of a given application.

In various exemplary embodiments, the system 10 and method 300 are run based on predetermined events, and/or can run continuously during operation of the vehicle 12. The method 300 starts at 310 with receiving a user specified input with an input device. At 320, the method 300 identifies a recognized word based on the user specified input. At 330 grammar paths are excluded from a speech recognition engine based on an absence of the recognized word in the grammar paths. At 340 a user phrase is received with a microphone. At 350 a recognized phrase is selected from the non-excluded grammar paths based on the user phrase. The method 300 then proceeds to 310 and receives the user specified input as necessary.

In a non-limiting embodiment, the method 300 further includes 360 and provides the recognized phrase to a vehicle system. The method 300 then proceeds to 310 and receives the user specified input as necessary. In a non-limiting embodiment, the vehicle system includes at least one of a navigation system, a communication system, a vehicle control system or a combination thereof.

In a non-limiting embodiment, the method 300 further includes 370 and 380. At 370, the method 300 identifies a position of the user specified input within the non-excluded grammar paths, At 380, additional grammar paths are excluded based on the position of the user specified input. The method 300 then proceeds to 340 and receives the user phrase.

In a non-limiting embodiment, the method 300 further includes 390 and 395. At 390, the method 300 displays the recognized phrase and at 395, the recognized phrase is confirmed with a user confirmation. The method 300 then proceeds to 310 and receives the user specified input as necessary.

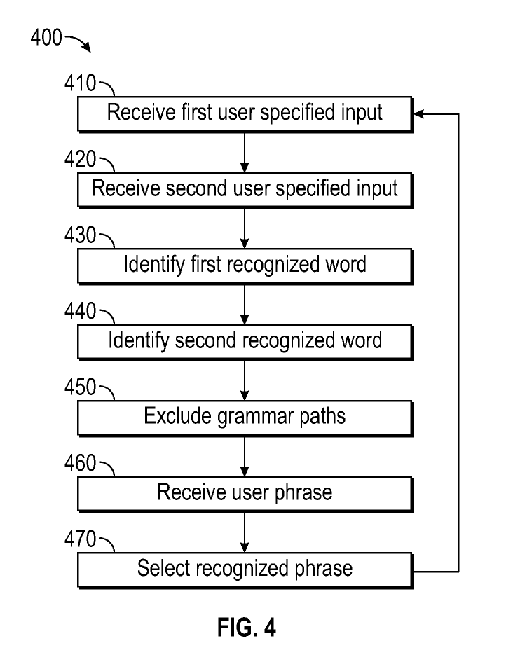

Referring now to FIG. 4, and with continued reference to FIGS. 1-3, a flowchart illustrates a method 400 performed by the system 10 for performing speech recognition in accordance with the present disclosure. As can he appreciated in light of the disclosure, the order of operation within the method 400 is not limited to the sequential execution as illustrated in FIG. 4, but may be performed in one or more varying orders as applicable and in accordance with the requirements of a given application. In addition, the order of operation of method 400 may be combined with the order of operation of method 300 where permissible.

In various exemplary embodiments, the system 10 and method 400 are run based on predetermined events, and/or can run continuously during operation of the vehicle 12. The method 400 starts at 410 with receiving a first user specified input with a first input device. At 420 a second user specified input is received with a second input device. The method 400 proceeds to 430 and identifies a first recognized word based on the first user specified input. At 440 the method 400 identifies a second recognized word based on the second user specified input. The method 400 proceeds to 450 and excludes grammar paths from the speech recognition engine based on the absence of the first and second recognized words in the grammar paths. At 460 the method 400 receives the user phrase and proceeds to 470 and selects the recognized phrase from the non-excluded grammar paths based on the user phrase. The method 400 proceeds to 410 and receives the first user specified input as necessary.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way, Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A system for performing speech recognition comprising:
a speech recognition engine including a plurality of grammar paths each defining a recognized phrase, the grammar paths each having at least two nodes connected by a recognized word;
an input device configured to receive a user specified input corresponding to the recognized word;
a microphone configured to receive a user phrase; and
a processor configured to exclude grammar paths from the speech recognition engine based on an absence of the user specified input and select the recognized phrase from the non-excluded grammar paths based on the user phrase.

2. The system of claim 1, wherein the input device includes at least one of a keyboard, a cursor control device, a touchscreen, or a combination thereof.

3. The system of claim 1, wherein the processor is further configured to identify a position of the user specified input within the non-excluded grammar paths and exclude additional grammar paths based on the position.

4. The system of claim 1, wherein the processor is further configured to provide the recognized phrase to a vehicle system.

5. The system of claim 4, wherein the vehicle system includes at least one of a navigation system, a communication system, a vehicle control system, or a combination thereof.

6. The system of claim 1, further comprising a display configured to display the recognized phrase.

7. The system of claim 1, further comprising:
a first input device configured to receive a first user specified input corresponding to a first recognized word; and
a second input device configured to receive a second user specified input corresponding to a second recognized word,
wherein the processor is configured exclude grammar paths from the speech recognition engine based on an absence of the first and second specified inputs, and determine the recognized phrase based on the user phrase and the non-excluded grammar branches.

8. A system for simplifying grammar paths in a speech recognition engine, the system comprising:
an input device configured to receive a user specified input corresponding to a recognized word of the grammar paths;
a microphone configured to receive a user phrase; and
a processor configured to exclude grammar paths from the speech recognition engine based on an absence of the user specified input and select the recognized phrase from the non-excluded grammar paths based on the user phrase.

9. The system of claim 8, wherein the input device includes at least one of a keyboard, a cursor control device, a touchscreen, or a combination thereof.

10. The system of claim 8, wherein the processor is further configured to identify a position of the user specified input within the non-excluded grammar paths and exclude additional grammar paths based on the position.

11. The system of claim 8, wherein the processor is further configured to provide the recognized phrase to a vehicle system.

12. The system of claim 11, wherein the vehicle system includes at least one of a navigation system, a communication system, a vehicle control system, or a combination thereof.

13. The system of claim 1, further comprising a display configured to display the recognized phrase.

14. A method for performing speech recognition, comprising:
receiving a user specified input with an input device;
identifying a recognized word based on the user specified input;
excluding grammar paths from a speech recognition engine based an absence of the recognized word in the grammar paths;
receiving a user phrase with a microphone; and
selecting a recognized phrase from the non-excluded grammar paths based on the user phrase.

15. The method of claim 14, wherein the input device includes at least one of a keyboard, a cursor control device, a touchscreen, or a combination thereof.

16. The method of claim 14, further comprising:
receiving a first user specified input with a first input device;
receiving a second user specified input with a second input device;
identifying a first recognized word based on the first user specified input;
identifying a second recognized word based on the second user specified input;
and
excluding grammar paths from the speech recognition engine based on and absence of the first and second recognized words in the grammar paths.

17. The method of claim 14, further comprising providing the recognized phrase to a vehicle system.

18. The method of claim 17, wherein the vehicle system includes at least one of a navigation system, a communication system, a vehicle control system, or a combination thereof.

19. The method of claim 14, further comprising:
identifying a position of the user specified input within the non-excluded grammar paths; and
excluding additional grammar paths based on the position.

20. The method of claim 14, further comprising:
displaying the recognized phrase; and
confirming the recognized phrase with a user confirmation.
